(19) United States
(12) Patent Application Publication
(10) Pub. No.: US 2008/0279097 A1
(43) Pub. Date: Nov. 13, 2008

(54) Methods, Systems, and Computer Program Products for Network Device Congestion Relief

(76) Inventors: Nicholas F. Campion, Rochester, MN (US); Keith D. Cramer, Pine Island, MN (US); Donald A. Morrison, Rochester, MN (US); Daniel J. Strauss, Rochester, MN (US)

Correspondence Address: CANTOR COLBURN LLP - IBM ROCHESTER DIVISION, 20 Church Street, 22nd Floor, Hartford, CT, 06103, US

(21) Appl. No.: 11/746,367

(22) Filed: May 9, 2007

(51) Int. Cl. H04L 12/56

(52) U.S. Cl. 370/229

(57) ABSTRACT

A method, system, and computer program product for network device congestion relief are provided. The method includes receiving a level of congestion for a network device, receiving a data packet including a codec list, and determining a filter policy based on the level of congestion. The method further includes applying the filter policy to the data packet to remove at least one codec from the codec list when a filter policy condition is met, resulting in a filtered data packet, and outputting the filtered data packet.

### BACKGROUND OF THE INVENTION

The present disclosure relates generally to communication networks, and, in particular, to methods, systems, and computer program products for network congestion relief.

In many streaming-content applications through a network, such as streaming audio and/or video, the most important aspect of performance is real-time delivery. Timely delivery of streaming content is particularly vital in interactive communications, e.g., voice over Internet protocol (VoIP). However, many existing networks are challenged to meet demands associated with real-time delivery of streaming content. For example, a substantial percentage of existing networks for business VoIP customers cannot support real-time voice delivery. Attempting to support streaming content often leads to congested, unresponsive networks. VoIP and other such streaming-content applications pose two large demands on network resources, real-time delivery and bandwidth consumption. Each network device in a network, such as a router or switch, may encounter variable loading effects while in operation, as numerous types of network traffic can pass through each network device. Streaming-content applications are typically bandwidth intensive and thus add increased demands to network devices that handle such applications. As network devices become heavily loaded with network traffic, congestion often results, leading to high latency and potentially lost data packets.

To reduce bandwidth demands in a network, a common approach is to compress or encode streaming content at the source, and decompress or decode the streaming content at the destination using a “codec”. Numerous codecs have been developed for audio and/or video applications. Different codecs, typically embodied in software, provide a varying balance between required bandwidth and content quality (e.g., loss of clarity due to compression). Some codecs provide high quality audio and/or video with higher bandwidth consumption, while other codecs provide lower quality audio and/or video with lower bandwidth consumption.

One solution for managing issues associated with sending streaming content through a network is to allow end-user client devices to dynamically select which codecs they use. The problem with this solution is that the end-user client devices, e.g., the users' phones, typically select a codec by sending each other a full list of supported codecs and then choose one codec that matches on both ends. The end-user client devices then monitor the communication and use heuristic formulas to determine if the communication performance has degraded, e.g., choppy audio and/or video. If an end-user client device determines that the communication performance has degraded, it may send a request to the other end-user client device to switch to another codec that uses less bandwidth. While this approach to bandwidth management may be effective in some situations, the approach is problematic for at least two reasons. First, if the network is already congested, starting out with a codec that demands high bandwidth can cause the streaming content to become badly mangled (e.g., choppy or silent). Second, the end-user client devices cannot know how congested the network is and may over-correct, dropping to a very low bandwidth codec when such a response is unnecessary. Conversely, the end-user client devices may under-correct, causing the problem to continue for an extended period.

Another solution for managing issues associated with sending streaming content through a network is to use quality of service (QoS) equipment, which routes select packets with priority over other network traffic. While priority based routing is almost always necessary in high-demand streaming-content applications, this solution does not ease the burden on the network. The solution merely dictates that select traffic gets priority. QoS equipment can mitigate the effects of other network traffic (e.g., HTTP, FTP, file transfers) on streaming-content quality, but cannot do the opposite. Presumably, this is the desired effect, but without a very sophisticated network deployment strategy, total network effectiveness may be lowered.

While the aforementioned solutions to managing issues associated with sending streaming content through a network may work in some cases, they fail to account for existing congestion in network devices when selecting a codec. Thus network device congestion may be compounded through the selection of a high bandwidth codec when congestion exists, resulting in poor communication quality and extended delays for lower priority network traffic.

Accordingly, there is a need in the art for relieving network device congestion.

### BRIEF SUMMARY OF THE INVENTION

Embodiments of the invention include a method for network device congestion relief. The method includes receiving a level of congestion for a network device, receiving a data packet including a codec list, and determining a filter policy based on the level of congestion. The method further includes applying the filter policy to the data packet to remove at least one codec from the codec list when a filter policy condition is met, resulting in a filtered data packet, and outputting the filtered data packet.

Additional embodiments include a method for network device congestion relief. The method includes determining a level of congestion for a network device, and intercepting a session initiation protocol (SIP) OPTIONS packet from an end-user client device, where the SIP OPTIONS packet includes a codec list. The method also includes determining a filter policy based on the level of congestion, and applying the filter policy to the SIP OPTIONS packet to remove at least one codec from the codec list when a filter policy condition is met, resulting in a filtered SIP OPTIONS packet. The method further includes outputting the filtered SIP OPTIONS packet when the filter policy condition is met, and outputting an unfiltered SIP OPTIONS packet when the filter policy condition is not met.

Further embodiments include a system for network device congestion relief. The system includes a network device in communication with at least one end-user client device. The network device includes a codec filter agent. The codec filter agent receives a level of congestion for a network device, receives a data packet including a codec list from the at least one end-user client device, and determines a filter policy based on the level of congestion. The codec filter agent further applies the filter policy to the data packet to remove at least one codec from the codec list when a filter policy condition is met, resulting in a filtered data packet, and outputs the filtered data packet.

Additional embodiments include a computer program product for network device congestion relief. The computer program product includes a storage medium readable by a processing circuit and storing instructions for execution by the processing circuit for implementing a method. The method includes receiving a level of congestion for a network device, receiving a data packet including a codec list, and determining a filter policy based on the level of congestion. The method further includes applying the filter policy to the data packet to remove at least one codec from the codec list when a filter policy condition is met, resulting in a filtered data packet, and outputting the filtered data packet.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an exemplary system for network device congestion relief that may be utilized by exemplary embodiments;

FIG. 2A depicts an exemplary packet flow through a network device with low network device congestion;

FIG. 2B depicts an exemplary packet flow through a network device with high network device congestion; and

FIG. 3 depicts an exemplary process flow that may be implemented by exemplary embodiments for network device congestion relief.

The detailed description explains the preferred embodiments of the invention, together with advantages and features, by way of example with reference to the drawings.

### DETAILED DESCRIPTION OF THE INVENTION

Exemplary embodiments, as shown and described by the various figures and the accompanying text, provide methods, systems and computer program products for network device congestion relief. In exemplary embodiments, end-user client devices communicate through a network of network devices. When the end-user client devices communicate using streaming content, such as voice over Internet protocol (VoIP) or video conferencing, the demand placed on network devices can be substantial, resulting in increased network device congestion (e.g., high demand of available bandwidth). While the use of codecs assists in compressing content to reduce bandwidth requirements for audio and/or video communications, a wide range of bandwidths may need to be supported by network devices. Selecting a codec with a high bandwidth requirement typically results in high quality communication (e.g., minimal losses due to compression) through a network; however, if a network device in the network becomes congested due to excessive network traffic, a high bandwidth codec may perform poorly (e.g., dropped packets, long delays, and the like). In exemplary embodiments, a network device monitors for an exchange of supported codec lists that occurs upon initiation of communication between end-user client devices, filtering the lists to remove codecs that are unsuitable based on the current level of network device congestion.

In exemplary embodiments, an end-user client device initiates communication through a network using one or more session initiation protocol (SIP) packets. One or more of the SIP packets may include a list of supported codecs. In alternate exemplary embodiments, other protocol formats are supported that include codec information, such as Media Gateway Control Protocol (MGCP) and H.323. An end-user client device receiving a codec list from the initiating end-user client device compares the codec list to a list of supported codecs and selects a codec based upon a match. The selected codec is typically the codec providing the highest quality, and consequently the highest bandwidth requirement. In exemplary embodiments, a network device uses a codec filtering agent and a congestion monitor to react to congestion conditions and filter the exchange of supported codecs. Filtering reduces the list of codecs exchanged between end-user client devices such that the codecs, which are unsuitable to the current level of network device congestion, are removed as options. Filtering may be defined using one or more filter policies to block or select codecs based on meeting one or more filter policy conditions. In exemplary embodiments, the filtering is transparent to the end-user client devices. This control mechanism enables network devices to avoid high congestion, while maintaining the ability to effectively handle streaming content without requiring any changes to existing end-user client devices. Codec filtering may also be applied when bridging multiple networks.

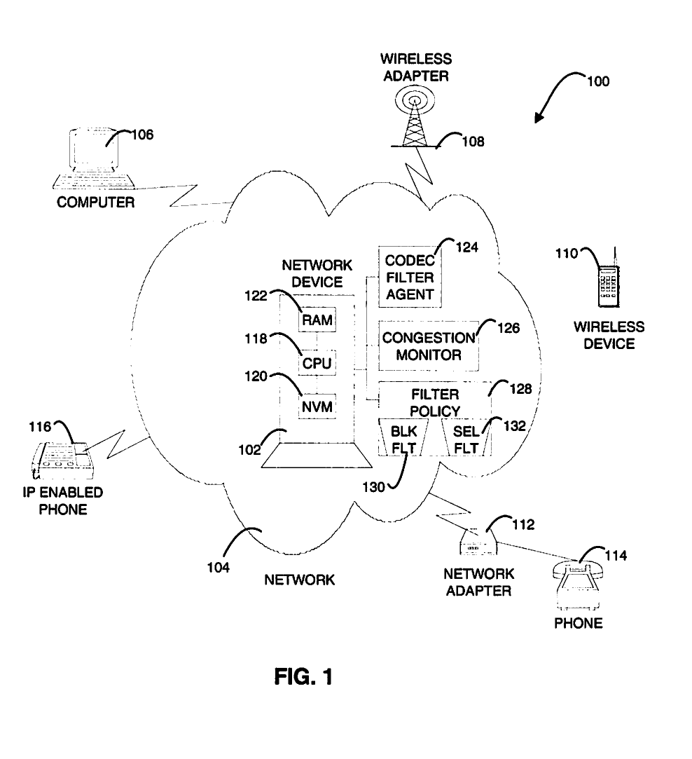

Turning now to the drawings, it will be seen that in FIG. 1 there is a block diagram of a system 100 for providing network congestion relief that is implemented in accordance with exemplary embodiments. The system 100 of FIG. 1 includes a network device 102 in communication with end-user client devices over a network 104. A variety of end-user client devices may communicate through the network 104, such as a computer 106, a wireless adapter 108 in communication with a wireless device 110, a network adapter 112 in communication with a phone 114, and an Internet protocol (IP) enabled phone 116. It will be understood that any number of end-user client devices can communicate through the network 104, including other devices known in the art, which are not depicted in FIG. 1, e.g., a Web-enabled camera. While only one network device 102 is depicted in the network 104 of FIG. 1, it will be understood that any number of network devices can be included in the network 104, the combination of which can be in communication with each other or isolated in separate communication paths. In exemplary embodiments, the network 104 includes multiple network devices, such as the network device 102, in communication with each other forming a communication fabric. The network 104 may include a combination of wired, wireless, and fiber optic communication links. The network 104 represents any deployment architecture known in the art, such as the Internet, an intranet, an extranet, a wide area network (WAN), a local area network (LAN), or any combination thereof.

The network device 102 may be any network communication device known in the art capable of receiving and processing packetized data, such as a router, a switch, a bridge, a network firewall, or a communications server. In exemplary embodiments, the network device 102 receives and sends or forwards data packets in compliance with the open systems interconnection (OSI) model, the transmission control protocol/Internet protocol (TCP/IP) model, and/or other communication protocol models. The network device 102 includes at least one processing circuit (e.g., CPU 118), non-volatile memory (e.g., NVM 120), and volatile memory (e.g., RAM 122). The CPU 118 may be any processing circuit technology known in the art, including for example, a microprocessor, a microcontroller, an application specific integrated circuit (ASIC), a programmable logic device (PLD), a digital signal processor (DSP), or a multi-core/chip module (MCM). The NVM 120 may be any non-volatile memory technology known in the art, such as ROM, PROM, EPROM, EEPROM, flash memory, NOVRAM or any other electric, magnetic, optical or combination memory device capable of storing data (i.e., a storage medium), some of which represent executable instructions for the CPU 118. The NVM 120 may also represent a secondary storage element, such as a hard disk device, that can be internal or external to the network device 102. The RAM 122 represents any volatile memory or register technology that does not retain its contents through a power/depower cycle, which can be used for holding temporary data, such as communication packets sent through the network 104. The RAM 122 may comprise multiple memory banks partitioned for different purposes, such as data cache, program instruction cache, and temporary storage for various data structures.

In exemplary embodiments, the various devices depicted in communication through the network 104, such as the computer 106, the wireless adapter 108 in communication with the wireless device 110, the network adapter 112 in communication with the phone 114, and the IP enabled phone 116, are capable of directly or indirectly sending and receiving audio and/or video streaming content. For example, the computer 106 may comprise a desktop or general-purpose computer device that transmits and/or receives streaming content through the network 104 using VoIP or video conferencing technology. Adapters such as the wireless adapter 108 and the network adapter 112 enable devices (e.g., the wireless device 110 and the phone 114) to communicate over the network 104 by translating communication signal formats between the network 104 and the associated devices. Some devices, such as the IP enabled phone 116, may have integrated network communication technology that combines the functionality of the network adapter 112 and the phone 114 into a single device. In exemplary embodiments, devices sending and receiving audio and/or video streaming content through the network 104 support one or more codecs to encode and decode the streaming content.

In exemplary embodiments, the network device 102 includes a codec filter agent 124, a congestion monitor 126, and a filter policy 128. The codec filter agent 124 and the congestion monitor 126 may be software applications residing in the NVM 120 and executable by the CPU 118. The codec filter agent 124 and the congestion monitor 126 may be managed and configured as separate applications or combined into a single comprehensive application. In alternate exemplary embodiments, either or both of the codec filter agent 124 and the congestion monitor 126 are implemented in hardware. In exemplary embodiments, the filter policy 128 is a file, table, or other data format that is read and applied by the codec filter agent 124. The filter policy 128 may be stored in the NVM 120 such that its contents are retained through a power/depower cycle. In alternate exemplary embodiments, the filter policy 128 includes instructions executable for the CPU 118. In further alternate exemplary embodiments, the filter policy 128 is dynamically generated or received and stored in the RAM 122. The filter policy 128 may also be combined with the codec filter agent 124 and/or the congestion monitor 126. In exemplary embodiments, the network device 102 is field updateable such that a technician or network administrator can modify the codec filter agent 124, the congestion monitor 126, and/or the filter policy 128. The specific contents of the filter policy 128 can be established by a network administrator, and updated as necessary. The network administrator may also enable or disable the codec filter agent 124.

The codec filter agent 124 acts as an intercepting and modifying agent to ensure that end-user client devices can only select a codec that should function adequately based upon the level of congestion of the network device 102. In exemplary embodiments, the codec filter agent 124 monitors data packets received by the network device 102. When a data packet containing SIP information is detected, the codec filter agent 124 inspects the data packet for a codec configuration request. The codec configuration request may be embedded as a list of supported codecs within an “OPTIONS” packet (see, for example, Request for Comments (RFC) 3261 Section 11.1). In alternate exemplary embodiments, other protocol formats are supported that include codec information, such as MGCP and H.323. For example, a MGCP packet may include a preferred compression format list of supported codecs, such as “L: p: 10 a:aLaw;uLaw;iLBC;GSM” (see, for example, RFC 2705 Section 3.2.2.2). The codec filter agent 124 parses the list of supported codecs to determine if any of the supported codecs are unsuitable based on the level of congestion of the network device 102. The codec filter agent 124 may periodically receive the level of congestion determination from the congestion monitor 126. In alternate exemplary embodiments, the codec filter agent 124 receives the level of congestion determination from the congestion monitor 126 upon demand. The codec filter agent 124 applies the filter policy 128 to determine which codec or codecs are best suited for the current level of congestion, filtering the data packet consistent with the filter policy 128 before the data packet is output from the network device 102. In exemplary embodiments, filtering performed by the codec filter agent 124 is transparent to the end-user client devices. Further details are provided herein.

In exemplary embodiments, the congestion monitor 126 monitors the flow of network traffic, i.e., packets, into and out of the network device 102. The congestion monitor 126 may compare the total available bandwidth of the network device 102 with the amount of bandwidth currently utilized to determine a level of congestion for the network device 102. The level of congestion may be determined as a percentage of bandwidth utilized relative to total potential bandwidth of the network device 102. For example, if the network device 102 supports a one gigabit-per-second communication link and the average throughput measured through the network device 102 is 700 megabits-per-second then the percent congestion would be 70%. In alternate exemplary embodiments, the congestion monitor 126 calculates the level of congestion using feedback information from other network devices, such as the number of dropped packets and the number of packets successfully received from the network device 102.

In exemplary embodiments, the filter policy 128 utilizes information about known codecs and their associated characteristics (e.g., required bandwidth, bit rate, packet size, and the like) to establish which codec or codecs should be permitted or blocked based on the network device 102 level of congestion. An example of the type of information utilized to establish the filter policy 128 is provided in table 1; however, many other codecs and characteristics not shown in table 1 may also be incorporated in the filter policy 128. The filter policy 128 may include a wide variety of policies using either a blocking filter 130 (e.g., allow all except blocked codecs) and/or a selection filter 132 (e.g., allow only selected codecs). For example, the filter policy 128 may include a filter policy condition that determines whether the level of congestion is above a threshold value of 75%. The threshold value of 75% may map to a policy of blocking any ADPCM codec using the block filter 130 when the filter policy condition is met (i.e., remove ADPCM from the list of supported codecs in the codec configuration request data packet), while retaining all remaining codecs in the data packet. Another example of the filter policy 128 is: when the level of congestion is below 50%, allow only uLaw codecs; otherwise, allow only iLBC codecs using the selection filter 132.

TABLE 1
Exemplary Codecs and Associated Characteristics

| Codec | Characteristics |
|---|---|
| GIPS Family | 13.3 Kbps and up |
| GSM | 13 Kbps (full rate), 20 ms frame size |
| iLBC | 15 Kbps, 20 ms frame size: 13.3 Kbps, |
| | 30 ms frame size |
| ITU G.711 | 64 Kbps, sample-based. Also known as |
| | aLaw/uLaw PCM. |
| ITU G.722 | 48/56/64 Kbps |
| ITU G.723.1 | 5.3/6.3 Kbps, 30 ms frame size |
| ITU G.726 | 16/24/32/40 Kbps |
| ADPCM | |
| ITU G.728 | 16 Kbps |
| ITU G.729 | 8 Kbps, 10 ms frame size |
| Speex | 2.15 to 44.2 Kbps |
| LPC10 | 2.5 Kbps |
| DoD CELP | 4.8 Kbps |

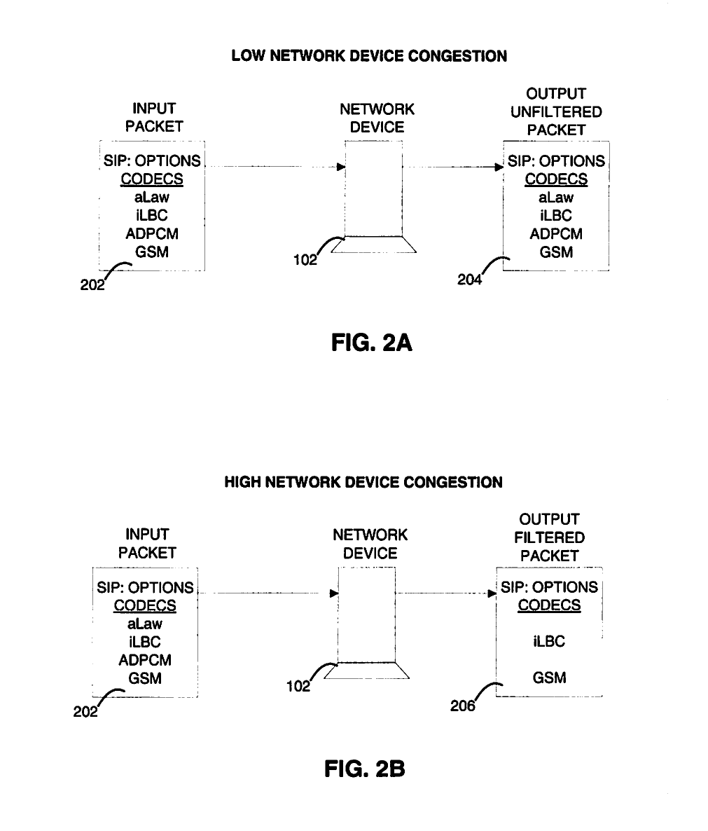

In exemplary embodiments, the codec filter agent 124 applies the filter policy 128 to an input data packet, resulting in outputting either an unfiltered or filtered data packet depending upon whether the filter policy condition is met. For example, FIGS. 2A and 2B depict scenarios in which the codec filter agent 124 of FIG. 1 applies the filter policy 128 of FIG. 1 with the blocking filter 130 of FIG. 1. For purposes of example, assume that the exemplary filter policy 128 of FIG. 1 includes a policy of blocking aLaw and ADPCM codecs when the level of congestion is over 60%. FIG. 2A depicts an exemplary input packet 202 entering the network device 102. The input packet 202 may be a SIP OPTIONS packet listing supported codecs of an end-user client device attempting to initiate communication with another end-user client device, e.g., a voice conversation between users of the phone 114 of FIG. 1 and the IP enabled phone 116 of FIG. 1 via VoIP. It will be understood that although the input packet 202 is depicted as a SIP OPTIONS packet, other protocols may be supported, as previously described. In the example depicted in FIG. 2A, the previously described policy is applied, but due to a low level of network device congestion (e.g., 40%), the filter policy condition is not met (i.e., the level of congestion is not over 60%). Thus, the input packet 202 passes through the network device 102 and is output as an unfiltered packet 204, maintaining the original codec list of the input packet 202. In the example depicted in FIG. 2B, the previously described policy is applied, and due to a high level of network device congestion (e.g., 80%), the filter policy condition is now met (i.e., the level of congestion is over 60%). Thus, the input packet 202 is filtered by the network device 102 and is output as a filtered packet 206, removing the aLaw and ADPCM codecs.

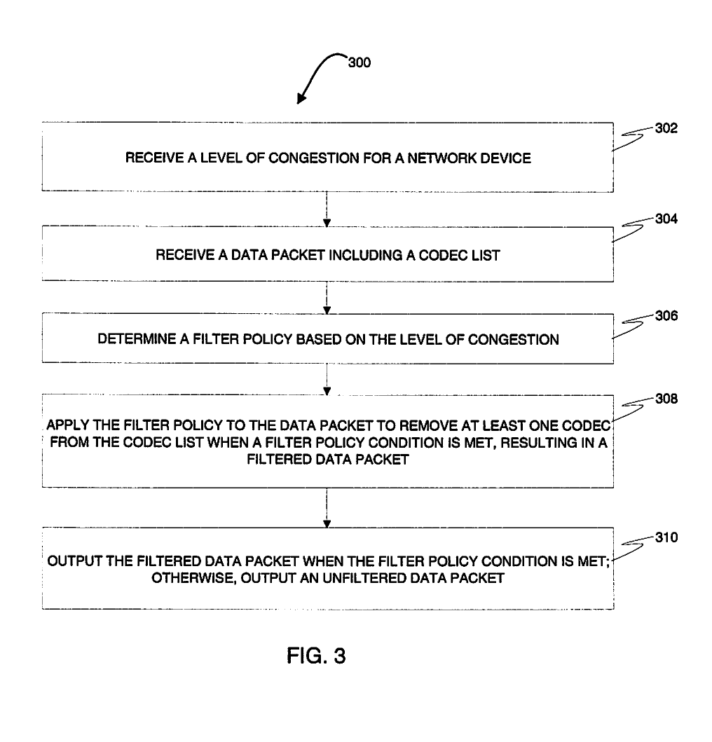

Turning now to FIG. 3, a process 300 for network device congestion relief will now be described in accordance with exemplary embodiments in reference to the system 100 of FIG. 1. In exemplary embodiments, the codec filter agent 124 provides congestion relief for the network device 102, in conjunction with the congestion monitor 126 and the filter policy 128. At block 302, the codec filter agent 124 receives a level of congestion for the network device 102. The congestion monitor 126 may determine the level of congestion for the network device 102 as a percentage of bandwidth utilized relative to the total potential bandwidth of the network device 102.

At block 304, the codec filter agent 124 receives a data packet including a codec list. The data packet may be a SIP OPTIONS packet, including audio and/or video codecs in the codec list (e.g., the input packet 202 of FIG. 2A), or another packet format that includes a list of codecs, e.g., MGCP or H.323.

At block 306, the codec filter agent 124 determines a filter policy 128 based on the level of congestion. The filter policy 128 may be determined via establishing a filter policy condition as a threshold value relative to the level of congestion (e.g., percent congestion >75%). The threshold value may be mapped to one or more codecs to block or select via filtering (e.g., above 75% maps to blocking GSM codecs). In exemplary embodiments, the filter policy 128 is set as filtering the codec list when the filter policy condition is met (e.g., block GSM codecs when percent congestion >75%). The filter policy 128 may include the blocking filter 130 for removing one or more blocked codecs from the codec list. The filter policy 128 may alternatively or additionally include the selection filter 132 for removing all codecs from the codec list except for one or more selected codecs. At block 308, the codec filter agent 124 applies the filter policy 128 to the data packet to remove at least one codec from the codec list when the filter policy condition is met, resulting in a filtered data packet.

At block 310, the codec filter agent 124 outputs the filtered data packet when the filter policy condition is met. However, if the filter policy condition is not met, then the codec filter agent 124 outputs an unfiltered data packet.

Technical effects of exemplary embodiments may include filtering a codec list from a data packet to remove one or more codecs from the codec list to prevent end-user client devices from establishing high bandwidth communication through a network device when the network device is congested. An advantage of exemplary embodiments may include reducing network device congestion. Employing a localized approach to filtering a codec list in a packet received by a network device may result in more precise control as each network device can monitor its own level of congestion and respond accordingly. Filtering a codec list may be performed transparently to the end-user client devices using one or more network devices, such that no modifications of end-user client device software and/or hardware are necessary to support codec filtering.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, universal serial bus (USB) drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for network device congestion relief, comprising:
receiving a level of congestion for a network device;
receiving a data packet including a codec list;
determining a filter policy based on the level of congestion;
applying the filter policy to the data packet to remove at least one codec from the codec list when a filter policy condition is met, resulting in a filtered data packet; and
outputting the filtered data packet.

2. The method of claim 1 further comprising:
determining the level of congestion for the network device as a percentage of bandwidth utilized relative to total potential bandwidth of the network device.

3. The method of claim 1 wherein determining the filter policy further comprises:
determining the filter policy condition as a threshold value relative to the level of congestion;
mapping the threshold value to one or more codecs to block or select via filtering; and
setting the filter policy as filtering the codec list when the filter policy condition is met.

4. The method of claim 1 wherein the filter policy includes a blocking filter, the blocking filter removing one or more blocked codecs from the codec list.

5. The method of claim 1 wherein the filter policy includes a selection filter, the selection filter removing all codecs from the codec list except for one or more selected codecs.

6. The method of claim 1 wherein the data packet is at least one of a session initiation protocol (SIP) packet, a Media Gateway Control Protocol (MGCP) packet, and an H.323 packet.

7. The method of claim 1 wherein the codec list includes at least one of an audio codec and a video codec.

8. The method of claim 1 further comprising:
outputting an unfiltered data packet when the filter policy condition is not met, wherein the unfiltered data packet includes the codec list.

9. A method for network device congestion relief, comprising:
determining a level of congestion for a network device;
intercepting a session initiation protocol (SIP) OPTIONS packet from an end-user client device, the SIP OPTIONS packet including a codec list;
determining a filter policy based on the level of congestion;
applying the filter policy to the SIP OPTIONS packet to remove at least one codec from the codec list when a filter policy condition is met, resulting in a filtered SIP OPTIONS packet;
outputting the filtered SIP OPTIONS packet when the filter policy condition is met; and
outputting an unfiltered SIP OPTIONS packet when the filter policy condition is not met.

10. A system for network device congestion relief comprising:
a network device in communication with at least one end-user client device, the network device including a codec filter agent, the codec filter agent performing:
receiving a level of congestion for a network device;
receiving a data packet including a codec list from the at least one end-user client device;
determining a filter policy based on the level of congestion;
applying the filter policy to the data packet to remove at least one codec from the codec list when a filter policy condition is met, resulting in a filtered data packet; and
outputting the filtered data packet.

11. The system of claim 10 further comprising a congestion monitor, the congestion monitor determining the level of congestion for the network device as a percentage of bandwidth utilized relative to total potential bandwidth of the network device.

12. The system of claim 10 wherein determining the filter policy further comprises:
determining the filter policy condition as a threshold value relative to the level of congestion;
mapping the threshold value to one or more codecs to block or select via filtering; and
setting the filter policy as filtering the codec list when the filter policy condition is met.

13. The system of claim 10 wherein the filter policy includes a blocking filter, the blocking filter removing one or more blocked codecs from the codec list.

14. The system of claim 10 wherein the filter policy includes a selection filter, the selection filter removing all codecs from the codec list except for one or more selected codecs.

15. The system of claim 10 wherein the data packet is a session initiation protocol (SIP) packet, a Media Gateway Control Protocol (MGCP) packet, and an H.323 packet.

16. The system of claim 10 wherein the codec list includes at least one of an audio codec and a video codec.

17. The system of claim 10 further comprising:
outputting an unfiltered data packet when the filter policy condition is not met, wherein the unfiltered data packet includes the codec list.

18. A computer program product for network device congestion relief, the computer program product comprising:
a storage medium readable by a processing circuit and storing instructions for execution by the processing circuit for implementing a method, the method comprising:
receiving a level of congestion for a network device;
receiving a data packet including a codec list;
determining a filter policy based on the level of congestion;
applying the filter policy to the data packet to remove at least one codec from the codec list when a filter policy condition is met, resulting in a filtered data packet; and
outputting the filtered data packet.

19. The computer program product of claim 18 further comprising:
determining the level of congestion for the network device as a percentage of bandwidth utilized relative to total potential bandwidth of the network device.

20. The computer program product of claim 18 wherein determining the filter policy further comprises:
determining the filter policy condition as a threshold value relative to the level of congestion;
mapping the threshold value to one or more codecs to block or select via filtering; and
setting the filter policy as filtering the codec list when the filter policy condition is met.

21. The computer program product of claim 18 further comprising:
outputting an unfiltered data packet when the filter policy condition is not met, wherein the unfiltered data packet includes the codec list.
